(19) United States
(12) Patent Application Publication
(10) Pub. No.: US 2026/0344709 A1
(43) Pub. Date: Nov. 5, 2026

(54) COMPOSTABLE CAPSULE AND PRODUCTION THEREOF

(71) Applicant: Delica AG, Buchs (CH)

(72) Inventors: Franziska Dora FLEISCHLI, Luzern (CH); Ana Cristina CÁZARES GODOY, Olten (CH); Caroline SIEFARTH, Binningen (CH)

(73) Assignee: Delica AG, Buchs (CH)

(21) Appl. No.: 19/124,679

(22) PCT Filed: Oct. 31, 2023
(86) PCT No.: PCT/EP2023/080360

§ 371 Date: Apr. 25, 2025

(30) Foreign Application Priority Data
Oct. 31, 2022 (EP) 22204797.9

(51) Int. Cl. A23L 2/395

(52) U.S. Cl. CPC A23L 2/395

(57) ABSTRACT

The invention relates to a capsule, in particular for preparing a beverage by introducing water into the capsule. The capsule comprises a compact of a powder or a powder mixture. The compact is coated with at least one layer comprising at least one starch and at least one fatty acid. The at least one starch is an amylose-containing starch, preferably with an amylose content (w/w) between 10% and 40%, preferably between 14% and 40% and most preferably between 14% and 25%. The invention also relates to a method for producing such a capsule and to the use of such a capsule.

The present invention relates to a compostable capsule and a method for producing such a capsule and the use of such a capsule according to the features of the general terms of the independent claims.

The provision of luxury foodstuff such as coffee in capsule form is well known. However, the materials commonly used as wrapping materials, such as plastics or aluminum (e.g. EP 0 468 079 A1), have the disadvantage that they can only be recycled with great effort and are usually not compostable.

Biodegradable coffee capsules are known. DE 10 2018 201 187 B3 describes a capsule made from a wood material compounded with bioplastic. However, the problem with such capsules made from compostable materials lies in their processing. Although these capsules can be produced using injection molding technology depending on the material used, dimensional accuracy is difficult to guarantee due to the high fiber content. In particular, sealing contours, which enable the preparation of a beverage under high pressure, are difficult to form with low tolerances.

DE 10 2014 000 187 B4 describes a further biodegradable capsule made from a coffee powder compact coated with a biodegradable layer. For this purpose, the coffee compact is preferably coated with liquid cellulose made from polysaccharides, a spacer of polyol and a crosslinker. DE 10 2014 000 187 B4 also mentions a coating layer of vegetable starch and fatty acid but does not provide any information about the type of starch, the fatty acid or details of mixing ratios.

It is therefore an objective of the invention to overcome the disadvantages of the prior art. In particular, a capsule for preparing a beverage is to be provided which is compostable. It is also an objective of the invention to provide a method for such a capsule as well as a use.

These objectives are solved by the devices and methods defined in the independent patent claims. Further embodiments are shown in the dependent claims.

A first aspect of the invention relates to a capsule, in particular for preparing a beverage by introducing water into the capsule. The capsule comprises a compact of a powder or a powder mixture and the compact is coated with at least one layer comprising at least one starch and at least one fatty acid. The at least one starch of the coating layer is an amylose-containing starch, preferably with an amylose content (w/w) between 10% and 40%, preferably between 14% and 40% and most preferably between 14% and 25%.

Surprisingly, it turned out that not all starches are suitable for producing a coating layer for a capsule. Rather, it was found that the starch must have a certain amylose content. Starches without amylose, for example waxy corn starch or waxy rice starch, did not produce homogeneous films for applying the coating to the compact.

The compact is at least partially, preferably completely, coated with the at least one layer. This protects the compact as far as possible from moisture.

The capsule can be understood as the compact with at least one layer or the compact can additionally be coated with a compostable capsule body, for example made of cellulose. In the second case, the at least one layer of starch and fatty acid is preferably applied to the capsule body and increases the dimensional stability during beverage preparation and improves the barrier properties against oxygen and moisture. Of course, in the case of an additional capsule body, it is conceivable that the powder or the powder mixture is present as bulk material and not as a compact. The following remarks on coating apply equally to a coated compact and a coated capsule body.

According to the present invention, a “compact” is understood to be a core material that has been compacted under pressure. The provision of the core material of the capsule as a compact is advantageous if the core material is at least partially coated according to the invention by immersion, coating or spraying with the coating according to the invention, so that it does not disintegrate during the coating process. The core material therefore preferably has a certain strength. This can preferably be achieved by compacting the core material with a compression pressure in the range of 1-100 MPa, preferably 5-50 MPa, so that the resulting compact has a strength in the range of 3-120 N, preferably 5-60 N.

The compression pressure to be applied to produce the compact depends on the properties of the core material, in the case of coffee powder, for example, on the degree of grinding, degree of roasting and moisture content of the powder. In the case of coffee powder, in particular, it can be observed that powder with a lower fat or oil content, e.g. decaffeinated coffee powder or coffee powder with a light roast color, requires a higher compression pressure in order to achieve a stable compact.

The strength of the compact is determined by positioning the compact between two plates of a compression-tensile testing machine (for example, equipped with an Xforce P force transducer from Zwick/Roell) and determining the force required to crush the compact. This method is also described in WO 2008/123775 A1, p.3.

The at least one layer may comprise at least one polyol, preferably selected from the group consisting of: aliphatic polyols, preferably ethylene glycol, propanediol, butylene glycol, triethylene glycol, polyethylene glycol, polypropylene glycol, erythritol, xylitol and most preferably sorbitol and glycerol; cyclic polyols, preferably glucose, fructose, mannose, galactose, oligofructose, inulin, isomaltulose, trehalose; sugar substitutes, preferably mannitol, isomalt, maltitol, lactitol; and aromatic polyols, preferably cyanidin, corilagin, digallic acid, tannic acid and gallic acid; and combinations thereof.

Polyol makes it easier to apply the film that forms the coating. The film is less brittle and therefore less susceptible to cracking after drying. Polyol also prevents the formation of grease residues on the beverage after it has been prepared.

It was surprisingly found that the fatty acid and the polyol react with each other, at least in part, to form a monofatty acid ester. Monofatty acid esters are insoluble in water and form waxy masses. This further improves the moisture barrier of the coating.

Preferably, the at least one fatty acid is selected from the group consisting of: palmitic acid, stearic acid, oleic acid, linoleic acid, γ-linoleic acid, eicosapentaenoic acid (EPA), docosahexaenoic acid (DHA) and combinations thereof. EPA and DHA are particularly preferred in a compact from a powder mixture containing milk powder.

The at least one fatty acid enables the film to be applied to form the coating. Fatty acids prevent the liquid coating medium from seeping into the compact.

Advantageously, the at least one starch is selected from the group consisting of: Cereal starches, preferably corn starch, wheat starch, rye starch, barley starch, millet starch, oat starch, potato starch, tapioca starch, pea starch; and combinations thereof. These starches have an ideal amylose content. Tests with waxy corn starch or waxy rice starch, which have no or only a very low amylose content, were difficult to handle.

A ratio (w/w) of starch to fatty acid in the layer can be between 15.0:1.0 and 2.0:1.0, preferably between 10.0:1.0 and 4.0:1.0, and particularly preferably between 7.0:1.0 and 5.0:1.0. At a ratio of 15.0:1.0, the solution to be applied is very viscous, but can still just be applied. At a ratio of 2.0:1.0 to 4.0:1.0, the solutions are very fluid, depending on the strength used, so that they can still just be applied. A ratio between 10.0:1.0 and 4.0:1.0 is ideal, as the corresponding solutions are easy to apply and result in a homogeneous application quantity and appearance.

A ratio of 6.6:1.0 or 5.0:1.0 of starch to fatty acid is particularly preferred and gave the best results in terms of the quality of the coating and the applicability of the layer.

A ratio (w/w) of starch to fatty acid to polyol in the layer can be between 15.0:1.0:15.0 and 2.0:1.0:0.1, preferably between 10.0:1.0:10.0 and 4.0:1.0:0.5, and particularly preferably between 7.0:1.0:7.0 and 5.0:1.0:1.0. The ratio is selected in such a way that the corresponding solutions can be optimally applied and are neither too liquid nor too viscous.

A ratio of 6.6:1.0:1.6 of starch:fatty acid:polyol is particularly preferred and gave the best results for mixtures with polyol in terms of quality of the coating and applicability of the layer.

Preferably, the capsule has between 1 and 100 layers, preferably 2 and 50 layers and most preferably 2 and 10 layers.

The capsule can also have at least one layer of a cross-linked polysaccharide. The application of such an additional layer increases the stability of the compact and additionally protects it from oxygen. The at least one layer of a cross-linked polysaccharide is preferably applied to a layer of at least one starch and at least one fatty acid or between two layers of at least one starch and at least one fatty acid. Of course, the same layer arrangements are also possible for a coated capsule body.

Preferably, the Crosslinked Polysaccharide Is Formed From a Polysaccharide and at least one crosslinking agent. The polysaccharide is advantageously selected from the group comprising: alginates, carageenans, cellulose, cellulose derivatives, chitin, chitosan, pectins, guar, xanthan gum, locust bean gum, gum arabic, pullulan and agar; and combinations thereof. Preference is given to polysaccharides that have good food compatibility.

Such polysaccharides are easily accessible, generally of natural origin and therefore sustainable and can also be easily biodegraded.

The at least one crosslinking agent can be selected from compounds with one or more carbonyl and/or carboxyl functions, in particular dialdehydes, diketo compounds and di-, tri- or tetra-carboxylic acids; and combinations thereof. The diketo compounds may be 1, 2-diketones, preferably 2, 3-butanedione, 2, 3-pentanedione and 2, 3-hexanedione. The at least one crosslinking agent can also be a salt of a divalent or higher-valent cation, in particular an alkaline earth metal cation and most preferably CaCl₂.

However, the cross-linked polysaccharides can also be naturally cross-linked polysaccharides. Cellulose, for example, cross-links with each other to form fibrillar structures.

A capsule with at least one layer of corn starch, stearic acid and optionally glycerol or sorbitol is also preferred.

A capsule comprising at least one layer of corn starch, palmitic acid and glycerol is also preferred.

A capsule consisting of at least one layer of pea starch, stearic acid and glycerol is also preferred.

A capsule comprising at least one layer of rice starch, stearic acid and glycerol is also preferred.

It is also possible that the capsule comprises a coating of several layers and of a mixture of the aforementioned layers.

It is also conceivable that combinations with at least one cross-linked polysaccharide, preferably as described above, and at least one fatty acid are possible in addition to or instead of starch. Especially in combination with a polyol, preferably as described above, and the formation of water-insoluble monofatty acid esters, the moisture barrier of the coating can be improved. This protects in particular the compacts pressed from powder against water absorption.

Advantageously, the powder or powder mixture is selected from the group consisting of: Coffee, coffee blends, coffee substitute blends, tea, tea blends, cocoa, cocoa blends, drinking chocolate, milk powder, milk coffee blends, fruit milk, vegan milk substitutes, instant coffee, coffee substitute products and dry soup, and combinations thereof.

Preferably, the capsule has a round, in particular spherical, shape. However, it is also conceivable that the shape of the capsule essentially corresponds to other geometric bodies, such as for example a cube, cuboid, prism, pyramid, cylinder, truncated cone, cone, torus, ellipsoid, etc. It should be noted that any corners and edges are preferably not sharp, but rounded.

A further aspect of the invention relates to a method for preparing a capsule, in particular for preparing a beverage, by introducing water into the capsule, in particular a capsule as described above. The method comprises the steps of:
a) Providing a compact made from a powder or powder mixture,
b) applying a preparation comprising at least one starch and at least one fatty acid to the compact, wherein the at least one starch is an amylose-containing starch,
c) Drying the preparation to produce a coating.
In the case of an additional compostable capsule body, the method for preparing a capsule, in particular for preparing a beverage, by introducing water into the capsule, in particular a capsule as described above, may comprise the following steps:
a) Providing a compostable capsule body, preferably made of cellulose,
b) Application of a preparation comprising at least one starch and at least one fatty acid to the compact, wherein the at least one starch is an amylose-containing starch,
c) Drying the preparation to produce a coating,
d) Filling the coated capsule body from step c) with a bulk material or compact, preferably a powder or powder mixture as described above,
e) Closure of the capsule body.

The following explanations apply equally to both procedures, unless otherwise stated.

The preparation is preferably present as a solution. The starch and the fatty acids may be selected from the groups as described above in relation to the capsule.

The Preparation May Additionally Comprise a Polyol, Preferably selected from the group consisting of: aliphatic polyols, preferably ethylene glycol, propanediol, butylene glycol, triethylene glycol, polyethylene glycol, polypropylene glycol, erythritol, xylitol and most preferably sorbitol and glycerol; cyclic polyols, preferably glucose, fructose, mannose, galactose, oligofructose, inulin, isomaltulose, trehalose; sugar substitutes, preferably mannitol, isomalt, maltitol, lactitol; and aromatic polyols, preferably cyanidin, corilagin, digallic acid, tannic acid and gallic acid; and combinations thereof.

The preparation may contain the at least one starch in a concentration of between 0.5% and 25.0%, preferably between 1.0% and 10.0%, and particularly preferably between 2.0% and 8.0%.

The concentration allows the starch to gelatinize into films, so that a layer can be formed.

The preparation may contain the at least one fatty acid in a concentration of between 0.1% and 3.0%, preferably between 0.2% and 2.0%, and particularly preferably between 0.3% and 1.0%.

It was surprisingly found that if the preparation with fatty acid is left to stand, it thickens. An optimum viscosity of the solution for application is achieved with the specified concentrations. Excessive turbidity of the fatty acid solution is prevented. However, the solution should be applied to the compact no later than 24 hours after preparation.

Advantageously, the preparation contains the at least one polyol in a concentration of between 0.1 to 4.0%, preferably between 0.5 to 3.0%, and particularly preferably between 1.0 to 2.0%.

When a polyol is added, the mixture of starch solution and fatty acid is additionally stabilized so that the polyol takes on the function of a mediator.

The Preparation Is Preferably Produced by Simultaneously Mixing the at least one fatty acid and the at least one starch, preferably with at least one polyol, in water and then heating.

Simultaneous mixing means that the starch only gelatinizes after all the substances have been added. For example, the starch can first be mixed with or without polyol with water and heated. Then the fatty acid is added and then the gelatinization takes place.

Alternatively, the preparation can be produced by stepwise mixing of the at least one starch in water with subsequent heating, followed by addition of the at least one fatty acid, and preferably at least one polyol.

In this process, the starch is gelatinized before other ingredients are added. For example, the starch can first be mixed with water and gelatinized at an elevated temperature.

Starch gelatinization is therefore preferably carried out before application in step b). Starch gelatinization is usually carried out at temperatures between 50 and 90° C. In principle, however, the gelatinization temperature depends on the selected starch and should be higher than the gelatinization temperature of the selected starch.

Ideally, the temperature of the mixture when the fatty acid is added is above the melting temperature of the corresponding fatty acid, regardless of whether simultaneous mixing or stepwise mixing is selected.

In the case of a coated compact, the compact obtained after step b) may have a high tackiness. For optimal drying of the coating without damage to the coatings resulting from tackiness, the following steps can be applied: i) the coated compact can be moved in step c) during drying; ii) the coated compact can be dried very quickly; iii) the coated compact can be dusted with powder from the outside; iv) the compact can be cooled or frozen; and v) the compact can be blown off with compressed air.

In the case of i), the coated compact can be rolled on a mesh belt, for example, and does not stick in the drying oven. In ii), the compact can be dried briefly at a very high temperature. The powder in iii) can be coffee. For example, it can be coffee residue from the production process. Dusting prevents the compact from sticking in a drying oven.

By “fast” in step ii) can be understood a drying time of less than 10 min, preferably less than 5 min, particularly preferably maximum 2 min, at a temperature of preferably greater than 100° C. As a result, the surface dries very quickly and can thus be dried undamaged to the final moisture content at gentle temperatures of preferably less than 100° C., preferably 70-85° C., particularly preferably 75 to 80° C.

Steps b) and c) can be repeated in order to apply several layers. Preferably, steps b) and c) are carried out 1 to 100 times, more preferably 2 to 50 times and most preferably 2 to 10 times. This applies both to the coating of the compact and to the coating of the capsule body.

One aspect of the invention also relates to a capsule produced by one of the methods as described above.

A further aspect of the invention relates to the use of a capsule as described above, preferably prepared by a method as described above, for the preparation of a beverage.

The invention is explained in more detail below with the aid of examples and figures. The examples and figures are for illustrative purposes and are not to be understood as limiting. It shows:

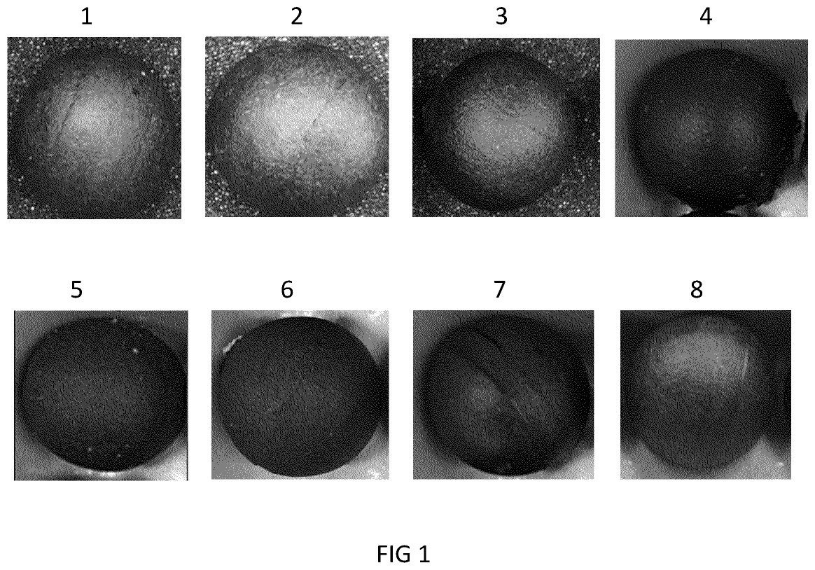

FIG. 1: The resulting compacts, produced according to examples 1 to 8 according to the invention.

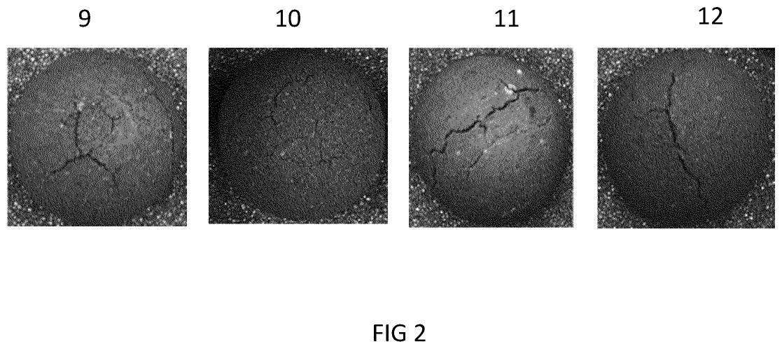

FIG. 2: The resulting compacts produced according to examples 9 to 12 not according to the invention.

### EXAMPLES

### Production of the Compacts

For each of the following examples, a spherical compact for coffee preparation was produced by compacting 5.7 g of roasted ground coffee powder in a press at 30 MPa. The coffee powder had a moisture content of 3.5 %. The average particle size of the coffee powder was 400 μm±100 μm.

### Example 1

Thingum 100 (corn starch, 25% amylose) and glycerol are dissolved in deionized water to give a concentration (w/w) of 4% starch and 1% glycerol. The mixture is then heated at 70° C. for 5 minutes. Stearic acid is then added to give a 0.6% solution. The mixture is then gelatinized at an elevated temperature of 90° C. for 30 min and cooled to room temperature.

The compact was immersed in the aqueous solution for 6 s and dried for approx. 6 min at 25° C. in an air stream. The compact was then immersed in the solution a second time for 6 s and then dried at 25° C. for 15 min.

The resulting coated compact 1 is shown in FIG. 1.

### Example 2

Thingum 100 is mixed with deionized water to produce a 4% starch solution. The starch solution is then gelatinized at an elevated temperature of 90° C. for 20 minutes. Glycerol and stearic acid are then added so that glycerol is present as a 1% solution and stearic acid as a 0.6% solution. These are incorporated at an elevated temperature, i.e. 90° C. for a further 20 min. The solution is then cooled to room temperature.

The coating of the compact is carried out according to Example 1. The resulting coated compact 2 is shown in FIG. 1.

### Example 3

Example 3 corresponds to example 1 with the difference that the gylcerol content is 2%.

The resulting coated compact 3 is shown in FIG. 1.

### Example 4

Rice starch is dissolved in deionized water to give a concentration (w/w) of 4% starch. The starch solution is then gelatinized at an elevated temperature of 90° C. for 20 minutes. Glycerol and stearic acid are then added so that glycerol is present as a 1% solution and stearic acid as a 0.6% solution. These are incorporated at an elevated temperature, i.e. 90° C. for a further 20 min. The solution is then cooled to room temperature.

The compact was immersed in the aqueous solution for 6 s and dried for approx. 6 min at 25° C. in an air stream. The compact was then immersed in the solution a second time for 6 s and then dried at 25° C. for 15 min.

The resulting coated compact 4 is shown in FIG. 1.

### Example 5

Pea starch (20-22% amylose) is dissolved in deionized water to a concentration (w/w) of 4% starch. The starch solution is then gelatinized at an elevated temperature of 90° C. for 20 minutes. Glycerol and stearic acid are then added so that glycerol is present as a 1% solution and stearic acid as a 0.6% solution. These are incorporated at an elevated temperature, i.e. 90° C. for a further 20 min. The solution is then cooled to room temperature.

The compact was immersed in the aqueous solution for 6 s and dried for approx. 6 min at 25° C. in an air stream. The compact was then immersed in the solution a second time for 6 s and then dried at 25° C. for 15 min.

The resulting coated compact 5 is shown in FIG. 1.

### Example 6

Example 6 corresponds to Example 5, whereby the concentrations (w/w) of starch are 2% and of stearic acid 0.6%.

The resulting coated compact 6 is shown in FIG. 1.

### Example 7

Example 7 corresponds to example 2, with the difference that palmitic acid is used instead of stearic acid.

The resulting coated compact 7 is shown in FIG. 1.

### Example 8

Thingum 100 (corn starch, 25% amylose) was dissolved in deionized water to give a concentration (w/w) of 4% starch. The starch solution is then gelatinized at an elevated temperature of 90° C. for 20 min. Sorbitol and stearic acid are then added so that sorbitol is present as a 2% solution and stearic acid as a 0.6% solution. These are incorporated at an elevated temperature, i.e. 90° C. for a further 20 min. The solution is then cooled to room temperature.

The compact was immersed in the aqueous solution for 6 s and dried for approx. 6 min at 25° C. in an air stream. The compact was then immersed in the solution a second time for 6 s and then dried at 25° C. for 15 min.

The resulting coated compact 8 is shown in FIG. 1.

### COMPARATIVE EXAMPLES

### Example 9

Example 9 corresponds to Example 1, with the exception that the solution was prepared without stearic acid.

The resulting compact 9 can be seen in FIG. 2.

### Example 10

Example 10 corresponds to example 3 without stearic acid.

The resulting compact 10 can be seen in FIG. 2.

### Example 11

Thingum 300 (waxy corn starch, 0% amylose) and glycerol are dissolved in deionized water to give a concentration (w/w) of 4% starch and 1% glycerol. The mixture is then heated to 70 °C. for 5 minutes. Stearic acid is then added to give a 0.6% solution. The mixture is then gelatinized at an elevated temperature of 90° C. for 30 minutes and cooled to room temperature.

The compact was immersed in the aqueous solution for 6 s and dried for approx. 6 min at 25° C. in an air stream. The compact was then immersed in the solution a second time for 6 s and then dried at 25° C. for 15 min.

The resulting compact 11 can be seen in FIG. 2.

### Example 12

Example 12 corresponds to example 11 without stearic acid. The resulting compact 12 can be seen in FIG. 2.

FIG. 1 shows coated compacts according to examples 1 to 8 of the invention. All capsules have a ball shape, the coating is smooth, mostly shiny and transparent.

The way in which the solution was prepared (i.e. mixing according to e.g. example 1 or example 2) did not play a significant role in the result of the coating.

FIG. 2 shows the compacts obtained according to the non-inventive comparative examples 9 to 12. The balls show cracks and no smooth and shiny coating. Balls coated with Thingum 300 solutions (examples 11 and 12) showed a less sticky behavior after application, but also cracks in the ball after drying.

1-15. (canceled)

16. A capsule for preparing a beverage by introducing water into the capsule, the capsule comprising a compact of a powder or a powder mixture and the compact being coated with at least one layer comprising at least one starch and at least one fatty acid, wherein the at least one starch is an amylose-containing starch.

17. The capsule according to claim 16, wherein the amylose content (w/w) is between 10% and 40%.

18. The capsule according to claim 16, wherein the at least one layer comprises at least one polyol.

19. The capsule according to claim 18, wherein the polyol is selected from the group consisting of: aliphatic polyols; cyclic polyols; sugar substitutes; and aromatic polyols; and combinations thereof.

20. The capsule according to claim 16, wherein the at least one fatty acid is selected from the group consisting of: palmitic acid, stearic acid, oleic acid, linoleic acid, γ-linoleic acid, eicosapentaenoic acid (EPA), docosahexaenoic acid (DHA) and combinations thereof.

21. The capsule according to claim 16, wherein the at least one starch is selected from the group consisting of: cereal starches; potato starch, tapioca starch, pea starch; and combinations thereof.

22. The capsule according to claim 16, wherein a ratio (w/w) of starch to fatty acid in the layer is between 15.0:1.0 and 2.0:1.0.

23. The capsule according to claim 18, wherein a ratio (w/w) of starch to fatty acid to polyol in the layer is between 15.0:1.0:15.0 and 2.0:1.0:0.1.

24. The capsule according to claim 16, wherein the powder or powder mixture is selected from the group consisting of: coffee, coffee blends, coffee substitute blends, tea, tea blends, cocoa, cocoa blends, drinking chocolate, milk powder, milk coffee blends, fruit milk, vegan milk substitutes, instant coffee, coffee substitute products and dry soup, and combinations thereof.

25. A method for preparing a capsule comprising the steps of:
providing a compact made from a powder or powder mixture,
applying a preparation comprising at least one starch and at least one fatty acid to the compact, wherein the at least one starch is an amylose-containing starch,
drying the preparation to produce a coating.

26. The method according to claim 25, wherein the preparation contains the at least one starch in a concentration of between 0.5% and 20.0%.

27. The method according to claim 25, wherein the preparation contains the at least one fatty acid in a concentration between 0.1% and 3.0%.

28. The method according to claim 25, wherein the preparation contains the at least one polyol in a concentration of between 0.1 to 4.0%.

29. The method according to claim 25, wherein the preparation is produced by simultaneously mixing the at least one fatty acid and the at least one starch in water and then heating.

30. The method according to claim 25, wherein the preparation is produced by mixing the at least one starch in water with subsequent heating, followed by addition of the at least one fatty acid.

31. A capsule prepared by a method according to claim 25.
